(19) United States
(12) Patent Application Publication
(10) Pub. No.: US 2025/0133500 A1
(43) Pub. Date: Apr. 24, 2025

(54) DATA PROCESSING METHOD AND DATA PROCESSING DEVICE

(71) Applicant: MEDIATEK INC., Hsinchu City (TW)

(72) Inventors: Chi-Peng CHANG, Hsinchu City (TW); Cheng-Jung HO, Hsinchu City (TW)

(21) Appl. No.: 18/922,944

(22) Filed: Oct. 22, 2024

Related U.S. Application Data
(60) Provisional application No. 63/592,215, filed on Oct. 23, 2023.

(51) Int. Cl. H04W 52/02

(52) U.S. Cl. CPC H04W 52/0235; H04W 52/027

(57) ABSTRACT

An embodiment of the disclosure provides a data processing method, which includes the following steps. A sync event is received by a first processor from a first driver. The first processor is woken up from a power saving mode after receiving the sync event. First data for a first function is decoded by the first processor. The decoded first data is transferred by the first processor to a first buffer. The power saving mode is entered by the first processor after transferring the decoded first data to the first buffer. The sync event is used to indicate that a second processor needs to wake up to process second data for a second function.

### CROSS REFERENCE TO RELATED APPLICATIONS

This application claims the benefit of U.S. Provisional Application No. 63/592,215, filed Oct. 23, 2023, the entirety of which is incorporated by reference herein.

### BACKGROUND OF THE DISCLOSURE

### Field of the Disclosure

The present disclosure relates to a processing method and a processing device, and, in particular, to a data processing method and a data processing device.

### Description of the Related Art

Generally, in the world of mobile phones, different modules may need to use the same system resources. However, when multiple modules need to operate independently from each other without an appropriate synchronization mechanism, these modules may compete for these resources, thereby increasing the system power consumption. Therefore, how to decrease the system power consumption has become an important issue.

### BRIEF SUMMARY OF THE DISCLOSURE

The present disclosure provides a data processing method and a data processing device, thereby improving the usage efficiency of the system resources, increasing the idle time of the system (such as the data processing device) and decreasing the system power consumption.

An embodiment of the present disclosure provides a data processing method, which includes the following steps. A sync event is received by a first processor from a first driver. The first processor is woken up from a power saving mode after receiving the sync event. First data for a first function is decoded by the first processor. The decoded first data is transferred by the first processor to a first buffer. The power saving mode is entered by the first processor after transferring the decoded first data to the first buffer. The sync event is used to indicate that a second processor needs to wake up to process second data for a second function.

An embodiment of the present disclosure provides a data processing device, which includes a first buffer, a first driver and a first processor. The first driver is configured to transmit a sync event. The first processor is configured to wake up from a power saving mode after receiving the sync event, decode first data for a first function, transfer the decoded first data to a first buffer, and enter the power saving mode after transferring the decoded first data to a first buffer. The sync event is used to indicate that a second processor needs to wake up to process second data for a second function.

According to the data processing method and data processing device disclosed by the present disclosure, the first driver transmits the sync event to the first processor. The first processor wakes up from the power saving mode after receiving the sync event, decodes the first data for the first function, transfers the decoded first data to the first buffer, and enters the power saving mode after transferring the decoded first data to a first buffer. The sync event is used to indicate that the second processor needs to wake up to process second data for a second function. Therefore, there is a synchronization mechanism for processing the first data and the second data, so that it may effectively improve the usage efficiency of the resources, increase the idle time of the system (such as the data processing device) and decrease the system power consumption.

### BRIEF DESCRIPTION OF THE DRAWINGS

The present disclosure can be more fully understood by reading the subsequent detailed description and examples with references made to the accompanying drawings, wherein:

FIG. 1 is a schematic view of a data processing device according to an embodiment of the present disclosure;

FIG. 2 is a schematic view of a data processing device according to another embodiment of the present disclosure;

FIG. 3 is a schematic view of an audio processor according to an embodiment of the present disclosure;

FIG. 4 is a flowchart of a data processing method according to an embodiment of the present disclosure;

FIG. 5 is a flowchart of a data processing method according to an embodiment of the present disclosure;

FIG. 6 is a flowchart of a data processing method according to an embodiment of the present disclosure; and

FIG. 7 is a flowchart of a data processing method according to an embodiment of the present disclosure.

### DETAILED DESCRIPTION OF THE DISCLOSURE

Technical terms of the present disclosure are based on general definition in the technical field of the present disclosure. If the present disclosure describes or explains one or some terms, definition of the terms is based on the description or explanation of the present disclosure. Each of the disclosed embodiments has one or more technical features. In possible implementation, a person skilled in the art would selectively implement all or some technical features of any embodiment of the present disclosure or selectively combine all or some technical features of the embodiments of the present disclosure.

In each of the following embodiments, the same reference number represents the same or a similar element or component.

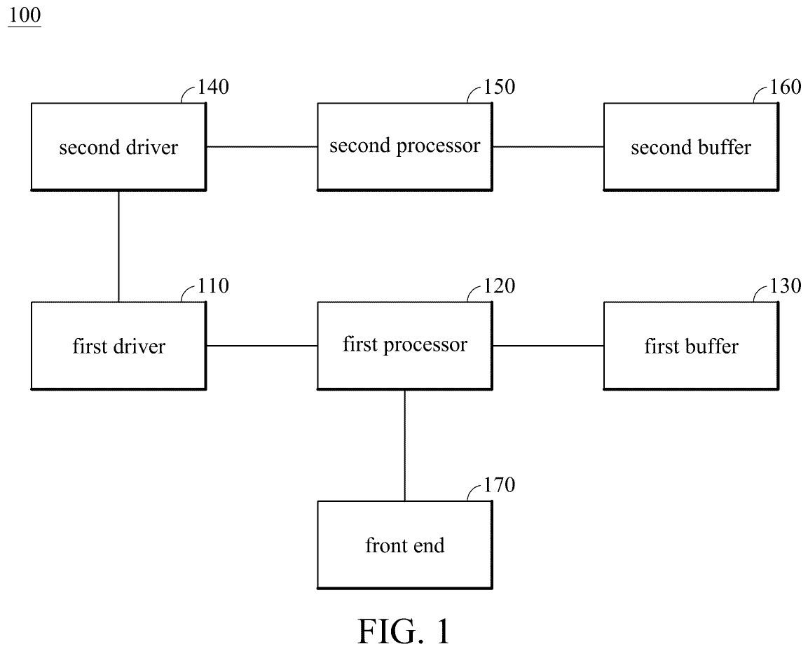

FIG. 1 is a schematic view of a data processing device according to an embodiment of the present disclosure. Please refer to FIG. 1. The data processing device 100 includes a first driver 110, a first processor 120 and a first buffer 130. The data processing device 100 also may include a second driver 140, a second processor 150, a second buffer 160 and a front end 170. The first driver 110 and the second driver 140 may run on a host processor, for example, a CPU. The first driver 110 and the second driver 140 may run on one host processor. Alternatively, the first driver 110 and the second driver 140 may run on different host processors.

The first driver 110 may receive a notification from the second driver 140 and transmit a sync event to the first processor 120. The notification is used to indicate that the second processor 150 needs to wake up to process second data for a second function. The sync event is used to indicate that the second processor 150 needs to wake up to process second data for the second function. The first processor 120 may wake up from a power saving mode after receiving the sync event, decode first data for a first function, transfer the decoded first data to the first buffer 130, and enter the power saving mode after transferring the decoded first data to the first buffer 130.

In some embodiments, the second driver 140 may periodically transmit the notification to the first driver 110 and the notification indicates that the second processor 150 needs to wake up to process the second data for the second function. The first driver 110 may periodically receive the notification and transmit the sync event to the first processor 120. Then, the first processor 120 may wake up periodically after receiving the sync event.

In some embodiments, the first driver 110 may be, for example, an audio driver, the second driver 140 may be, for example, a display driver, the first data may be, for example, audio data, and the second data may be, for example, image data, but the disclosure is not limited thereto. In some embodiments, the first processor 120 may be, for example, an audio processor, such as an audio digital signal processor (ADSP), and the second processor 150 may be, for example, an image processor, but the disclosure is not limited thereto. In some embodiments, the front end 170 may be, for example, an audio front end (AFE), but the disclosure is not limited thereto. The first function may play audio data, and the second function may display images. The second driver 140 may periodically transmit the notification to the first driver 110 when images need to be played.

In some embodiments, the second driver 140 may periodically generate a notice event when images need to be played, wherein the notice event is used for indicating that the image data for playing needs to be processed by the second processor 150. The second driver 140 may periodically transmit the notice event to the second processor 150. Then, the second processor 150 may periodically wake up from the power saving mode after receiving the notice event, decode the image data, transfer the decoded image data to the second buffer, and enter the power saving mode after transferring the decoded image data to the second buffer 160.

Therefore, there is a synchronization mechanism for waking up the first processor 120 and the second processor 150, so that the first processor 120 and the second processor 150 may wake up substantially synchronously. Because the first processor 120 and the second processor 150 may wake up substantially synchronously and use some resources synchronously, the usage efficiency of the resources is improved. Because the first processor 120 and the second processor 150 may make up substantially synchronously, the idle time of the system (such as the data processing device 100) is increased and the system power consumption is decreased.

In some embodiments, the first processor 120 may determine the presence of the audio data that needs to be played, and may notify the front end 170 to disable the transmission of interrupt request, wherein the audio data is matched with the images. Audio data may be audio data in a video, and the images may be the images in the video. Specifically, the first processor 120 may receive a first notice message from the host processor and receive the audio data from a processor (e.g. the host processor), wherein the first notice message is used for notifying the first processor 120 to play the audio data matched with the images. The first processor 120 may determine the presence of the audio data that needs to be played based on the first notice message.

In some embodiments, the first processor 120 may determine there is no audio data matched with the images that needs to be played and notify the front end 170 to enable the transmission of interrupt request. Specifically, the first processor 120 may receive a second notice message from the host processor, wherein the second notice message is used for notifying the first processor 120 the end of playing audio data matched with the images. The first processor 120 may determine there is no audio data matched with the images that needs to be played based on the second notice message.

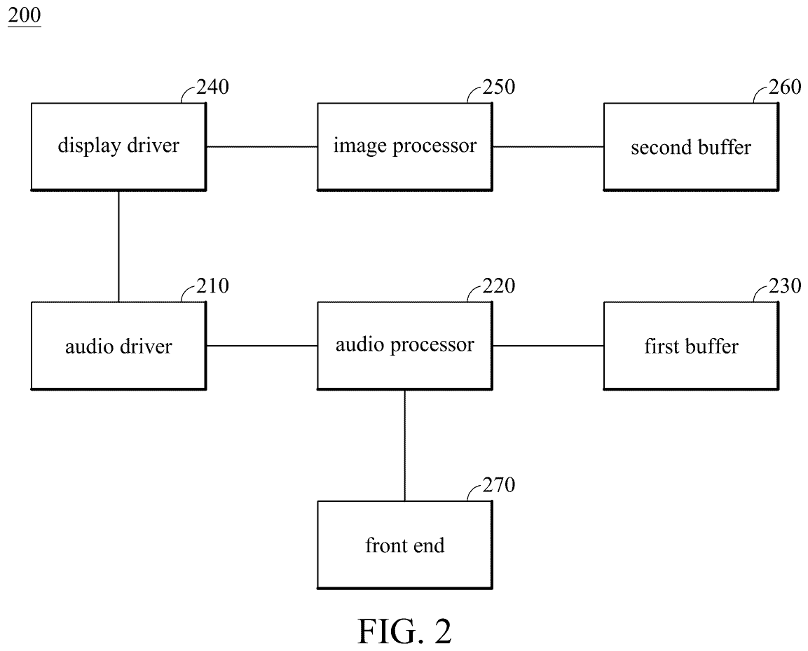

FIG. 2 is a schematic view of a data processing device according to an embodiment of the present disclosure. Please refer to FIG. 2. The data processing device 200 may include an audio driver 210, an audio processor 220, a display driver 240 and an image processor 250. The data processing device 200 also may include a first buffer 230, a second buffer 260 and a front end 270. In some embodiments, the audio driver 210, the audio processor 220, the display driver 240 and the image processor 250, the first buffer 230, the second buffer 260 and the front end 270 may be the same as or similar to the first driver 110, the first processor 120, the second driver 140, the second processor 150, the first buffer 130, the second buffer 160 and the front end 170.

The data processing device 200 can be applied to the scenarios where images are displayed while audio data is played.

The host processor in the data processing device 200 may transmit a first notice message for notifying the audio processor 220 that it needs to play audio data corresponding to images and send the audio data to the audio processor 220. The audio processor 220 may generate an offload task based on the first notice message, wherein the offload task may include a parameter for indicating the presence of audio data that needs to be played and the audio data is matched with images. The audio processor 220 may store the audio data in its buffer. The audio processor 220 may notify the front end 270 to disable a transmission of interrupt request (IRQ). The audio processor 220 may enter a sleep mode. In some embodiments, the front end 270 may be, for example, an audio front end (AFE). The host processor in the data processing device 200 may transmit a third notice message for notifying the image processor 250 that it needs to play images and send the images to the image processor 250. The image processor 250 may store the images in its buffer and enter a sleep mode.

The display driver 240 may generate a notification when one image needs to be played and transmit the notification to the audio driver 210. In some embodiments, images need to be played periodically, for example, 60 images per second. Therefore, the display driver 240 may periodically generate the notification, and periodically transmit the notification to audio driver 210, but the present disclosure is not limited thereto.

The audio driver 210 may periodically receive the notification from the display driver 240 and periodically transmit a sync event to the audio processor 220, wherein the sync event is used to indicate that the image processor 250 needs to wake up to process the image for playing. The display driver 240 and the audio driver 210 may be a software running on one host processor or different host processors. The display driver 240 and the audio driver 210 may run on a Kernal.

The audio processor 220 may be coupled to the first buffer 230. The audio processor 220 may periodically wake up from a power saving mode upon receiving the sync event from the audio driver 210, so as to perform subsequent operations. Then, the audio processor 220 may decode audio data in its buffer for playing the audio data. Afterward, the audio processor 220 may transfer the decoded audio data to the first buffer 230. Then, the audio processor 220 may enter the power saving mode after transferring the decoded audio data to the first buffer 230. The front end 270 may obtain the decoded audio data from the first buffer 230 and send it to a speaker for playing the decoded audio data. The audio processor 220 may be an audio digital signal processor (ADSP).

The display driver 240 may also send a notification event to the image processor 250 to wake it up when the image needs to be played. The image processor 250 may be coupled to the second buffer 260. The image processor 250 may periodically wake up from a power saving mode upon receiving the notification event from the display driver 240, so as to perform subsequent operations. Then, the image processor 250 may process an image and transfer the processed image to the second buffer 260. Then, the image processor 250 may enter the power saving mode after transferring the processed image to the second buffer 260. A front end (not shown) may obtain the image from the second buffer 260 and send it to a displayer for displaying the image. The front end may be integrated with the front end 270.

Therefore, there is a synchronization mechanism for waking up the audio processor 220 and the image processor 250, so that the audio processor 220 and the image processor 250 may wake up substantially simultaneously. Because the audio processor 220 and the image processor 250 may wake up substantially simultaneously and use some resources simultaneously, the usage efficiency of the resources is improved. Because the audio processor 220 and the image processor 250 may wake up substantially simultaneously, the idle time of the system (such as the data processing device 200) is increased and the system power consumption is decreased.

The host processor in the data processing device 200 may transmit a second notice message for notifying the audio processor 220 the end of playing audio data matched with the image data. The audio processor 220 may end the offload task and notify the front end 270 to enable a transmission of interrupt request (IRQ). After that, the audio processor 220 may enter sleep mode.

In addition to the scenario where images are displayed while the audio data is played, there are also some scenarios that only requires to playing the audio data. In such scenarios, the front end 270 may periodically send interrupt requests to the audio processor 220 to trigger the audio processor 220 to periodically send audio data to the first buffer 230. Then, the front end 270 may obtain the audio data from the first buffer 230 and send it to the speaker for playing. Therefore, the audio processor 220 may determine which scenario will be performed. If it is a scenario where images are displayed while the audio data is played, the audio processor 220 may notify the front end 270 to disable a transmission of interrupt request (IRQ). If it is a scenario where only audio data is played, the audio processor 220 does not notify the front end 270 to disable a transmission of IRQ.

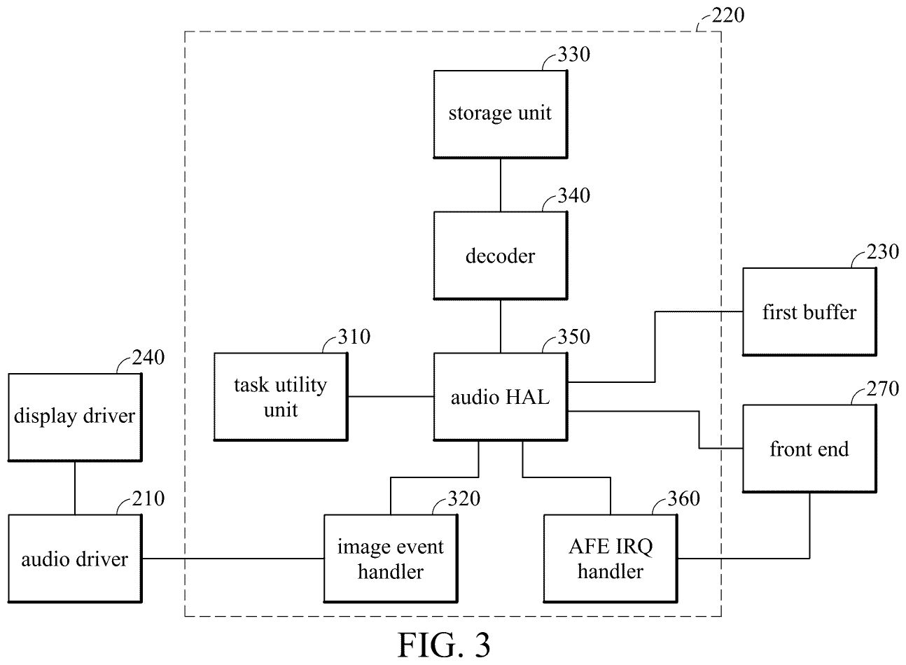

FIG. 3 is a schematic view of an audio processor according to an embodiment of the present disclosure. Please refer to FIG. 3. The audio processor 220 may include a task utility unit 310, an image event handler 320, a storage unit 330, a decoder 340, an audio HAL (hardware abstraction layer) 350 and AFE (audio front end) IRQ (interrupt request) handler 360.

The audio processor 220 may receive a first notice message for notifying the audio processor 220 that it needs to play audio data corresponding to images and receive the audio data. The audio data is stored in the storage unit 330. The audio processor 220 may generate an offload task based on the first notice message, wherein the offload task may include a parameter for indicating audio data corresponding to images is played. The task utility unit 310 may generate an enabling notification or a disabling notification according to task generated by the audio processor 220. For example, when the task utility unit 310 checks that the task is the offload task and the offload task includes the parameter for indicating the audio data corresponding to images is played, the task utility unit 310 may generate the disabling notification for notifying the front end 270 to disable the transmission of IRQ, so that the front end 270 may not transmit the interrupt request. When the task utility unit 310 checks that the task is not the offload task, the task utility unit 310 does not generate the disabling notification. After that, the audio processor 220 may enter a sleep mode.

The audio processor 220 may wake up upon receiving the sync event from the audio driver 210. The image event handler 320 in the audio processor 220 may receive the sync event from the audio driver 210 and generate a sync event notification.

The audio HAL 350 may be coupled to the image event handler 320, the decoder 340, the first buffer (such as the audio buffer) 230 and the front end 270. The audio HAL 270 may receive the sync event notification generated by the image event handler 320. The audio HAL 350 may notify the decoder 340 to decode the audio data. Specifically, the audio HAL 350 may, based on the usage of the first buffer (such as the audio buffer) 230, notify the decoder 340 to decode the audio data. For example, based on the remaining size of the first buffer (such as the audio buffer) 230, the audio HAL 350 instructs the decoder 340 on the amount of the audio data to decode. The decoder 340 may be coupled to the storage unit 330. The decoder 340 may decode the audio data stored in the storage unit 330 and transfer the decoded audio data to the audio HAL 350. The audio HAL 350 may transfer the decoded audio data to the first buffer (such as the audio buffer) 230. After the audio HAL 350 transfers the decoded first data to the first buffer (such as the audio buffer) 230, the audio processor 220 may enter the power saving mode. In some embodiments, the audio processor 220 may require some resources during its awake state, such as external memory interface (EMI) or clock resources, but the present disclosure is not limited thereto.

The audio processor 220 may receive a second notice message for notifying the audio processor 220 the end of playing audio data. The audio processor 220 may end the offload task. Specifically, the task utility unit 310 in the audio processor 220 may detect that the offload task is ended and notify the front end 270 to enable the transmission of the interrupt request, so that the front end 270 may (periodically) transmit the interrupt request. After that, the audio processor 220 may enter sleep mode.

In some scenarios that only requires to playing the audio data, the front end 270 may periodically send interrupt requests to the audio processor 220 to trigger the audio processor 220 to periodically send audio data to the first buffer (such as the audio buffer) 230. So, the AFE IRQ handler 360 in the audio processor 220 may be coupled to the audio HAL 350 and the front end 270. The AFE IRQ handler 360 may receive the interrupt request transmitted by the front end 270 and transmit the interrupt request to the audio HAL 350, so that the audio HAL 350 may perform the corresponding operation.

In some embodiments, the storage unit 330 may be, for example, a dynamic random access memory (DRAM).

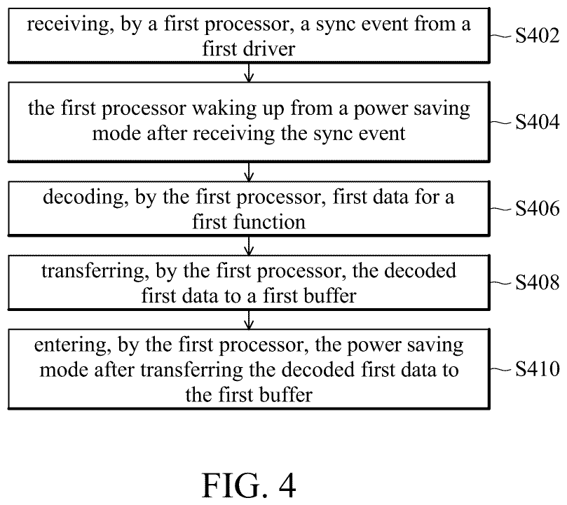

FIG. 4 is a flowchart of a data processing method according to an embodiment of the present disclosure. In step S402, the method involves receiving, by a first processor, a sync event from a first driver, wherein the first driver is used to drive a first processor. In step S404, the method involves the first processor waking up from a power saving mode after receiving the sync event. In step S406, the method involves decoding, by the first processor, first data for a first function.

In step S408, the method involves transferring, by the first processor, the decoded first data to a first buffer. In step S410, the method involves entering, by the first processor, the power saving mode after transferring the decoded first data to the first buffer. In the embodiment, the sync event is used to indicate that the second processor needs to wake up to process second data for a second function.

In some embodiments, step S402 may include periodically transmitting, by the first driver, the sync event to the first processor. In some embodiments, the first driver is an audio driver, the first data is audio data, and the second data is image data. The audio data may be audio data in a video, and the image data may be image data in the video.

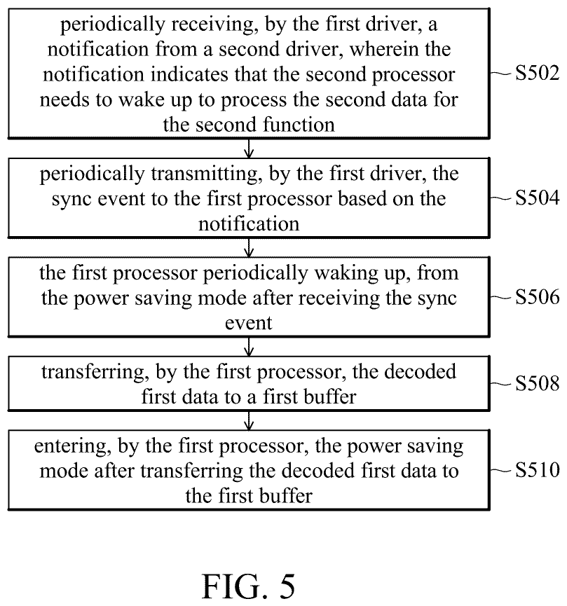

FIG. 5 is a flowchart of a data processing method according to an embodiment of the present disclosure.

In step S502, the method involves periodically receiving, by the first driver, a notification from a second driver, wherein the notification indicates that the second processor needs to wake up to process the second data for the second function. In step S504, the method involves periodically transmitting, by the first driver, a sync event to the first processor based on the notification. In step S506, the method involves the first processor periodically waking up, from the power saving mode after receiving the sync event. In the embodiment, steps S508˜S510 in FIG. 5 are the same as or similar to steps S408˜S410 in FIG. 4. Accordingly, steps S508˜S510 in FIG. 5 may refer to the description of the embodiment of FIG. 4, and the description thereof is not repeated thereto.

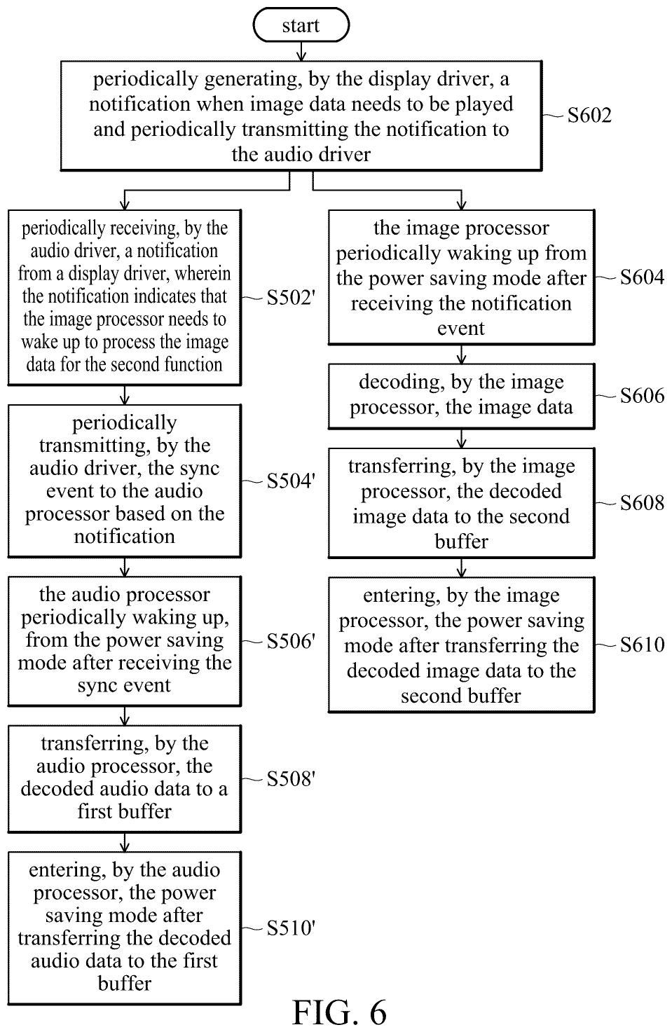

FIG. 6 is a flowchart of a data processing method according to an embodiment of the present disclosure. In the embodiment, steps S502′˜S510′ in FIG. 6 are similar to steps S502˜S510 in FIG. 5. In the embodiment, the first driver is an audio driver, the second driver is a display driver, the first data is audio data, and the second data is image data. In some embodiments, the audio data may be audio data in a video, and the image data may be image data in the video.

In step S602, the method involves periodically generating, by the display driver, a notification when image data needs to be played and periodically transmitting the notification to the audio driver, wherein the notification is used for indicating that the image processor needs to wake up to process the image data for playing. The method also involves periodically sending a notification event to the image processor to wake it up when the image data needs to be played, wherein the notification event is used for indicating the image data for playing needs to be processed by the image processor.

In step S604, the method involves the image processor periodically waking up from the power saving mode after receiving the notification event.

In step S606, the method involves decoding, by the image processor, the image data. In step S608, the method involves transferring, by the image processor, the decoded image data to the second buffer. In step S610, the method involves entering, by the image processor, the power saving mode after transferring the decoded image data to the second buffer.

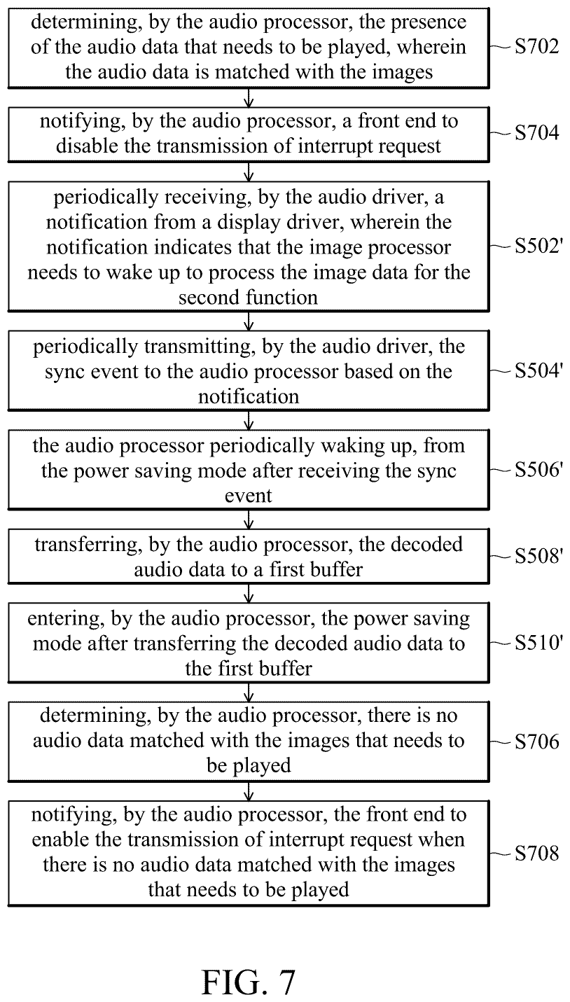

FIG. 7 is a flowchart of a data processing method according to an embodiment of the present disclosure. In the embodiment, steps S502′˜S510′ in FIG. 7 are similar to steps S502˜S510 in FIG. 5. In the embodiment, the first driver is an audio driver, the second driver is a display driver, the first data is audio data, and the second data is image data.

In step S702, the method involves determining, by the audio processor, the presence of the audio data that needs to be played, wherein the audio data is matched with the images. In step S704, the method involves notifying, by the audio processor, a front end to disable the transmission of interrupt request. In step S706, the method involves determining, by the audio processor, there is no audio data matched with the images that needs to be played. In step S708, the method involves notifying, by the audio processor, the front end to enable the transmission of interrupt request when there is no audio data matched with the images that needs to be played.

In some embodiments, step S702 may include receiving, by the audio processor, a first notice message from a host processor, wherein the first notice message is used for notifying the audio processor to play the audio data matched with the images; and receiving, by the audio processor, the audio data from the host processor. In some embodiments, step S706 may include receiving, by the audio processor, a second notice message from the host processor, wherein the second notice message is used for notifying the audio processor the end of playing audio data matched with the images.

In summary, there is a synchronization mechanism for waking up the audio processor and the image processor, so that the audio processor and the image processor may wake up substantially synchronously. Because the audio processor and the image processor may wake up substantially synchronously and use some resources synchronously, the usage efficiency of the resources is improved. Because the audio processor and the image processor may make up substantially synchronously, the idle time of the system (such as the data processing device 100) is increased and the system power consumption is decreased.

While the present disclosure has been described by way of example and in terms of the preferred embodiments, it should be understood that the present disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data processing method, comprising:
receiving, by a first processor, a sync event from a first driver;
the first processor waking up from a power saving mode after receiving the sync event;
decoding, by the first processor, first data for a first function;
transferring, by the first processor, the decoded first data to a first buffer; and
entering, by the first processor, the power saving mode after transferring the decoded first data to the first buffer;
wherein the sync event is used to indicate that a second processor needs to wake up to process second data for a second function.

2. The data processing method as claimed in claim 1, further comprising:
periodically receiving, by the first driver, a notification from a second driver, wherein the notification indicates that the second processor needs to wake up to process the second data for the second function; and
periodically transmitting, by the first driver, the sync event to the first processor based on the notification;
wherein the first processor wakes up periodically after receiving the sync event.

3. The data processing method as claimed in claim 2, wherein the first driver is an audio driver, the first data is audio data matched with image data, the second data is image data, and the notification is received by the first driver from the second driver when the image data needs to be played.

4. The data processing method as claimed in claim 3, further comprising:
periodically generating, by the second driver, a notice event when images need to be played, wherein the notice event is used for indicating the image data for the second function needs to be processed by the second processor;
periodically transmitting, by the second driver, the notice event to the second processor;
the second processor periodically waking up from the power saving mode after receiving the notice event;
decoding, by the second processor, the second data;
transferring, by the second processor, the decoded second data to the second buffer; and
entering, by the second processor, the power saving mode after transferring the decoded second data to the second buffer.

5. The data processing method as claimed in claim 3, further comprising:
determining, by the first processor, the presence of the audio data that needs to be played, wherein the audio data is matched with the image data; and
notifying, by the first processor, a front end to disable the transmission of interrupt request.

6. The data processing method as claimed in claim 5, wherein the step of determining, by the first processor, the presence of the audio data that needs to be played comprises:
receiving, by the first processor, a first notice message from a host processor, wherein the first notice message is used for notifying the first processor to play the audio data matched with the image data; and
receiving, by the first processor, the audio data.

7. The data processing method as claimed in claim 5, further comprising:
determining, by the first processor, there is no audio data matched with the image data that needs to be played; and
notifying, by the first processor, the front end to enable the transmission of interrupt request.

8. The data processing method as claimed in claim 7, wherein the step of determining, by the first processor, there is no audio data matched with the image data that needs to be played comprises:
receiving, by the first processor, a second notice message from a host processor, wherein the second notice message is used for notifying the first processor the end of playing audio data matched with the image data.

9. A data processing device, comprising:
a first buffer;
a first driver, configured to transmit a sync event; and
a first processor, configured to wake up from a power saving mode after receiving the sync event, decode first data for a first function, transfer the decoded first data to the first buffer, and enter the power saving mode after transferring the decoded first data to the first buffer;
wherein the sync event is used to indicate that a second processor needs to wake up to process second data for a second function.

10. The data processing device as claimed in claim 9, further comprising: a second driver, a second buffer and the second processor, wherein the first driver is further configured to periodically receive a notification from the second driver and the notification indicates that the second processor needs to wake up to process the second data for the second function;
wherein the first driver is further configured to periodically transmit the sync event to the first processor;
wherein the first processor is configured to wake up periodically after receiving the sync event.

11. The data processing device as claimed in claim 10, wherein the first driver is an audio driver, the first data is audio data matched with image data, the second data is image data, and the notification is received by the first driver from the second driver when the image data needs to be played.

12. The data processing device as claimed in claim 11, wherein the second driver is configured to periodically generate a notice event when images need to be played, wherein the notice event is used for indicating that the image data for the second function needs to be processed by the second processor; wherein the second driver is further configured to periodically transmit the notice event to the second processor; wherein the second processor is further configured to periodically wake up from the power saving mode after receiving the notice event, decode the second data, transfer the decoded second data to the second buffer, and enter the power saving mode after transferring the decoded second data to the second buffer.

13. The data processing device as claimed in claim 11, further comprising a front end, wherein the first processor is further configured to determine the presence of the audio data that needs to be played, and to notify the front end to disable the transmission of interrupt request, wherein the audio data is matched with the image data.

14. The data processing device as claimed in claim 13, wherein the first processor is further configured to receive a first notice message from a host processor and receive the audio data, wherein the first notice message is used for notifying the first processor to play the audio data matched with the image data.

15. The data processing device as claimed in claim 13, wherein the first processor is configured to determine there is no audio data matched with the image data that needs to be played, and to notify the front end to enable the transmission of interrupt request.

16. The data processing device as claimed in claim 15, wherein the first processor is further configured to receive a second notice message from a host processor, wherein the second notice message is used for notifying the first processor the end of playing audio data matched with the image data.
